(19) United States
(12) Patent Application Publication
(10) Pub. No.: US 2018/0079064 A1
(43) Pub. Date: Mar. 22, 2018

(54) PLANETARY TRANSMISSION

(71) Applicants: Clifford Feldmann, St. Cloud, FL (US); Paul Babcock, St. Cloud, FL (US); Michael Seifert, St. Cloud, FL (US); Dennis Gohlke, St. Cloud, FL (US); Nathan Sloma, St. Cloud, FL (US)

(72) Inventors: Clifford Feldmann, St. Cloud, FL (US); Paul Babcock, St. Cloud, FL (US); Michael Seifert, St. Cloud, FL (US); Dennis Gohlke, St. Cloud, FL (US); Nathan Sloma, St. Cloud, FL (US)

(21) Appl. No.: 15/712,022

(22) Filed: Sep. 21, 2017

Related U.S. Application Data
(60) Provisional application No. 62/397,821, filed on Sep. 21, 2016.

(51) Int. Cl. B25F 5/00; F16H 3/44; F16H 15/50; E21B 7/00; F25C 5/02

(52) U.S. Cl. CPC B25F 5/001; F16H 3/44; F25C 5/02; E21B 7/008; F16H 15/50

(57) ABSTRACT

An ice drill. The ice drill includes a power head, the power head configured to allow the user to control operation of the ice drill and an engine, the engine producing an output rotation at a crankshaft. The ice drill also includes a planetary transmission. The planetary transmission receives the output rotation from the crankshaft, changes the rotation speed by a specified ratio, and outputs the rotation at an output shaft, wherein the output rotation is left-handed in orientation. The ice drill further includes an auger, the auger attached to the output shaft and a cutting blade, the cutting blade configured to be moved by the auger to create a hole in ice.

### CROSS-REFERENCE TO RELATED APPLICATIONS

This application claims the benefit of and priority to U.S. Provisional Patent Application Ser. No. 62/397,821 filed on Sep. 21, 2016, which application is incorporated herein by reference in its entirety.

### BACKGROUND OF THE INVENTION

Current ice drill transmissions suffer from a number of drawbacks. In particular, they must be installed offset from the engine. This causes a number of issues. For example, it makes augers somewhat heavy on one side which adds to product instability when first starting to drill a hole in the ice. The lack of balance becomes quite a problem when running an ice auger at high speeds on pure ice.

Additionally, in a conventional transmission, the pinion gear is engaged to the main gear with minimal metal to metal tooth contact. Given the high speed and torque requirements of the cutting head design, this causes the pinon gears to be stripped if the force is excessive. This happens most often when the operator of the drill either did not drill in a perfectly vertical manner or would rock the drill assembly back and forth while drilling to clear ice chips. This also occurs when the cutting blades are dull which adds more stress to the transmission.

Accordingly, there is a need in the art for a transmission, which can be installed in line with the engine.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an ice drill. The ice drill includes a power head, the power head configured to allow the user to control operation of the ice drill and an engine, the engine producing an output rotation at a crankshaft. The ice drill also includes a planetary transmission. The planetary transmission receives the output rotation from the crankshaft, changes the rotation speed by a specified ratio, and outputs the rotation at an output shaft, wherein the output rotation is left-handed in orientation. The ice drill further includes an auger, the auger attached to the output shaft and a cutting blade, the cutting blade configured to be moved by the auger to create a hole in ice.

Another example embodiment includes an ice drill. The ice drill includes a power head. The power head configured to allow the user to control operation of the ice drill and an engine, the engine producing a right-handed output rotation at a crankshaft. The ice drill also includes a planetary transmission. The planetary transmission includes a pinion gear. The pinion gear is connected to the output rotation of the engine and receives the output rotation from the crankshaft. The planetary transmission also includes a set of planetary gears, the planetary gears each in operational contact with the pinion gear and a gear bracket, the gear bracket maintaining the position of the planetary gears relative to the pinion gear. The planetary transmission further includes a ring gear, the ring gear including inward facing teeth that are in operational contact with each of the planetary gears in the set of planetary gears such that the rotation speed has been changed by a specified ratio and the rotation has been changed to left-handed in orientation. The planetary transmission additionally includes an output shaft connected to the ring gear. The ice drill further includes an auger, the auger attached to the output shaft and a cutting blade, the cutting blade configured to be moved by the auger to create a hole in ice.

Another example embodiment includes an ice drill. The ice drill includes a power head. The power head configured to allow the user to control operation of the ice drill and an engine, the engine producing a right-handed output rotation at a crankshaft. The ice drill also includes a planetary transmission. The planetary transmission includes a housing and a pinion gear. The pinion gear is connected to the output rotation of the engine and receives the output rotation from the crankshaft. The planetary transmission also includes a set of planetary gears, the planetary gears each in operational contact with the pinion gear and a gear bracket, the gear bracket maintaining the position of the planetary gears relative to the pinion gear. The planetary transmission further includes a ring gear, the ring gear including inward facing teeth that are in operational contact with each of the planetary gears in the set of planetary gears such that the rotation speed has been changed by a specified ratio and the rotation has been changed to left-handed in orientation. The housing is releasably attached to the power head. The planetary transmission additionally includes an output shaft connected to the ring gear. The ice drill further includes an auger, the auger attached to the output shaft and a cutting blade, the cutting blade configured to be moved by the auger to create a hole in ice.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of an ice drill;

FIG. 2 illustrates an example of a cutting head;

FIG. 3 illustrates an example of a power head;

FIG. 4 illustrates an example of a reciprocating engine;

FIG. 5A illustrates an example of a fully assembled planetary transmission;

FIG. 5B illustrates an example of an expanded view of planetary transmission with a 15:1 gear ratio; and

FIG. 5C illustrates an example of an expanded view of planetary transmission with a 24:1 gear ratio.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

### I. Ice Drill

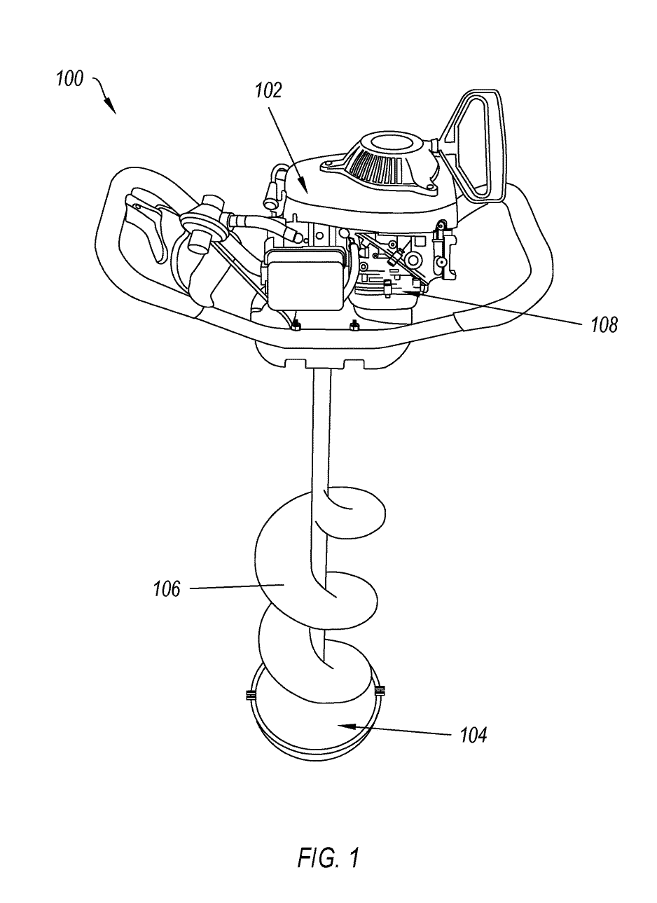

FIG. 1 illustrates an example of an ice drill 100. The ice drill 100 is used to create holes (the size of the hole generally suggested is 8 inches (20 cm)) in ice that covers a lake or other body of water and allows access to the water beneath the ice for fishing or other activities. E.g., the ice drill 100 can be used to create a hole in ice through which an angler can attempt to catch fish or perform some other activity.

FIG. 1 shows that the ice drill 100 can include a power head 102. The power head 102 allows a user to control the ice drill 100. In particular, the user holds to the power head 102 to use the ice drill 100 to create the desired hole. For example, the power head 102 can include a throttle, handles, etc. which allow the user to control the placement and operation of the ice drill 100.

FIG. 1 also shows that the ice drill 100 can include a cutting head 104. The cutting head 104 creates the hole in the ice. I.e., the cutting head 104 is the portion of the ice drill 100 which removes ice to create a hole through which fishing or other activities can occur. The cutting head 104 can be modified or exchanged in order to change the hole which will be created or to replace worn out parts.

FIG. 1 additionally shows that the ice drill 100 includes an auger 106. The auger 106 (or “bit”) is a helical screw which lifts the cut ice out of the hole. Typically, the cut ice “climbs” (i.e., is pushed up by cut ice produced by the cutting blade, described below) the auger 106 until it rises above the ice surface, at which point the rotating motion of the auger 106 causes the cut ice to exit the auger 106 where it collects on the surface of the ice.

FIG. 1 moreover shows that the ice drill 100 includes an engine 108. An engine 108 or motor is a machine designed to convert energy into useful mechanical motion. For example, an internal combustion engine burns fuel to produce power. This power is then used by the ice drill 100 to turn the cutting head 104 and the auger 106. Thus, the engine 108 burns propane in order to produce motion of the cutting head 104 and the auger 106 to remove ice, creating a hole in the ice.

### II. Cutting Head

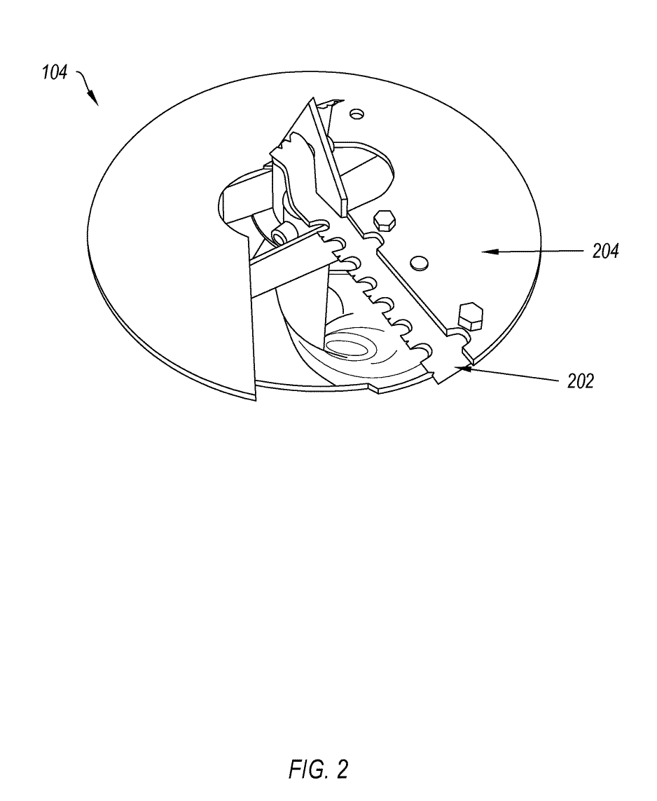

FIG. 2 illustrates an example of a cutting head 104. The cutting head 104 creates the hole in the ice. I.e., the cutting head 104 is the portion of the ice drill which actually removes ice. The cutting head 104, or portion thereof, may be replaced as they become dull or worn out. I.e., the cutting head 104, or portions thereof, may be removed from the ice drill by a user.

FIG. 2 shows that the ice drill can include a cutting blade 202. The cutting blade 202 creates the hole in the ice. In particular, the cutting blade 202 is angled so that as it rotates it digs into the ice and cut ice is removed from the hole that has been created. I.e., with each successive pass the cutting blade 202 passes lower into the ice, creating a new surface which will be removed in future passes.

FIG. 2 also shows that the ice drill can include a cutting disk 204. The cutting disk 204 creates an attachment point for the cutting blade 202 and helps to remove the ice that has been cut by the cutting blade 202. I.e., the cutting disk is mounted on a central shaft and rotated, which creates proper motion of the cutting blade 202. As the ice is cut by the cutting blade 202, the cut ice slides up the cutting blade 202 onto the cutting disk 204.

### III. Reciprocating Engine

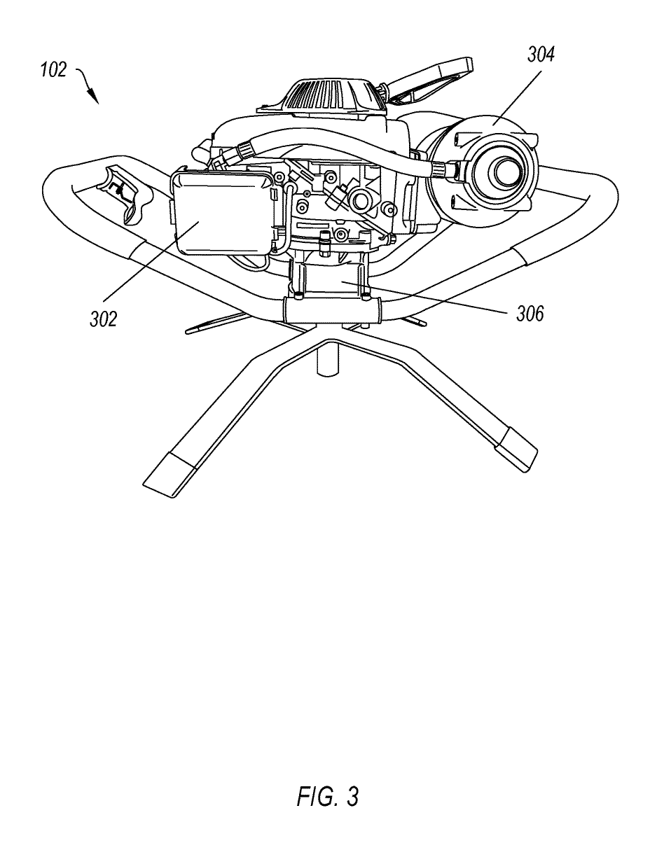

FIG. 3 illustrates an example of a power head 102. The power head is configured to allow the user to control operation of the ice drill. In particular, the user's hands will be on or near the drill power head 102, allowing the user to determine where the hole will be created and various factors of ice frill use, such as drill speed.

FIG. 3 shows that the power head 102 includes a propane carburetor 302. The propane carburetor 302 is a device that blends air and fuel for the engine 108. The propane carburetor 302 works on Bernoulli's principle: the faster air moves, the lower its static pressure, and the higher its dynamic pressure. I.e., the throttle (accelerator) linkage does not directly control the flow of liquid fuel. Instead, it actuates carburetor mechanisms which meter the flow of air being pulled into the engine 108. The speed of this flow, and therefore its pressure, determines the amount of fuel drawn into the airstream, as described below.

FIG. 3 also shows that the power head 102 includes a propane fuel source 304. The propane fuel source 304 includes any device which can provide propane to the engine 108. For example, the propane fuel source 304 can include a canister or other container which holds the propane fuel. Additionally or alternatively, the propane fuel source 304 can include a regulator or other device which controls the pressure or amount of propane available to the engine 108.

FIG. 3 further shows that the power head 102 can include a planetary transmission 306. The planetary transmission 306 includes an assembly of parts including the speed-changing gears and the propeller shaft by which the power is transmitted from an engine to a live axle. For example, in FIG. 1 the axle, via the transmission planetary 306, creates rotation of the cutting head 104 and the auger 106. By convention, in an ice drill the planetary transmission 306 must create left-hand rotation (counter clock-wise when viewing from above) rather than the right-hand rotation of most non-ice drill transmissions to prevent redesign of the other portions of the power head 102. The planetary transmission 306 can be changed by removing four bolts, which allows easy configuration to suit the needs of a user. This makes the planetary transmission 306 easy to remove and reinstall, even with very little mechanical knowledge or skill needed and allows for repairs in the field (therefore, downtime is virtually eliminated). Further, the planetary transmission 306 can be installed inline with the engine. This can be critical to prevent balancing issues.

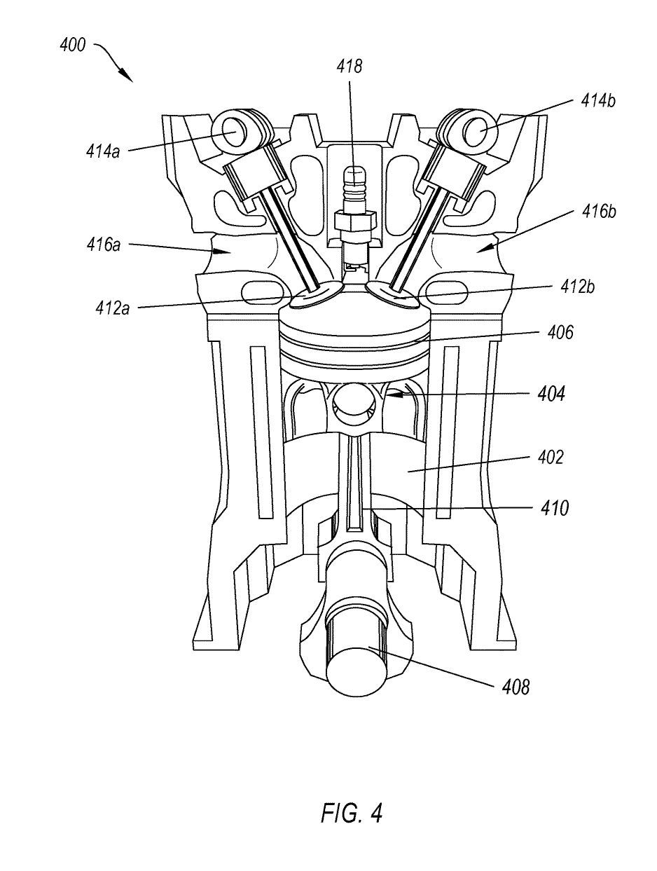

FIG. 4 illustrates an example of a reciprocating engine 400. In particular, a reciprocating engine 400 is a heat engine that converts pressure, from burning fuel or other sources, into a rotating motion used to produce work. Reciprocating engines 300 can include the internal combustion engine, the steam engine or a Stirling engine. One of skill in the art will appreciate that devices other than the reciprocating engine 400 can make use of implementations of the invention and that the reciprocating engine 400 is treated as exemplary, and not limiting, herein unless otherwise specified in the claims.

FIG. 4 shows that the reciprocating engine 400 can include a cylinder 402. The cylinder 402 is a chamber into which a gas is introduced, either already hot and under pressure (e.g., in a steam engine), or heated inside the cylinder 402 either by ignition of a fuel air mixture (e.g., in an internal combustion engine) or by contact with a hot heat exchanger in the cylinder 402 (e.g., in a Stirling engine). The hot gases can expand within the cylinder 402, with the energy of expansion converted into work, as described below.

FIG. 4 also shows that the reciprocating engine 400 can include a piston 404. The piston 404 can includes a solid piece of material tightly fitting and moving within the cylinder 402. The piston 404 can convert the energy produced by the gas expanding within the cylinder 402 into linear motion, which can be used to perform work, as described below. One of skill in the art will appreciate that in other applications, the function of the piston 404 can be reversed and force can be imparted to the piston 404 for the purpose of compressing or ejecting the fluid in the cylinder 402. Additionally or alternatively, the piston 404 also acts as a valve by covering and uncovering ports in the cylinder 402 wall.

One of skill in the art will appreciate that the reciprocating engine 400 can include more than one cylinder 402, each of which contains a piston 404. In general, the more cylinders 402 a reciprocating engine has, the more vibration-free (smoothly) it can operate. The power of a reciprocating engine can be proportional to the volume of the combined displacement of the pistons 404. In some implementations, the piston 404 may be powered in both directions in the cylinder 402 in which case it is said to be double acting. In the reciprocating engine 400 the cylinders 402 may be aligned in line, in a V configuration, horizontally opposite each other, or radially. Opposed-piston 404 engines can put two pistons 404 working at opposite ends of the same cylinder 402 and this has been extended into triangular arrangements such as the Napier Deltic.

It is common for such reciprocating engines 400 to be classified by the number and alignment of cylinders and the total volume of displacement of gas by the pistons 404 moving in the cylinders usually measured in cubic centimeters (cm³ or cc) or liters (l or L). For example, for internal combustion engines, single and two-cylinder designs are common in smaller vehicles such as motorcycles, while automobiles typically have between four and eight cylinders, and locomotives, and ships may have a dozen cylinders or more. Cylinder 402 capacities may range from 10 cm³ or less in model engines up to several thousand cubic centimeters in a ship's engines.

FIG. 4 further shows that the reciprocating engine 400 can include one or more piston rings 406. The piston rings 406 can provide an airtight seal between the sliding piston 404 and the walls of the cylinder 402 so that the high-pressure gas above the piston 404 does not leak past it and reduce the efficiency of the reciprocating engine 400. I.e., a better seal between the piston rings 406 and the cylinder 402 can equal higher engine output with reduced emissions and increase engine longevity due to reduced wear and reduced engine lubrication contamination. However, minor distortions in the piston can have a large effect on the seal between the piston rings 406 and the cylinder 402. The piston rings 406 can include hard metal rings which are sprung into a circular groove in the head of piston 404.

FIG. 4 additionally shows that the reciprocating engine 400 can include a crankshaft 408. The crankshaft 408, sometimes abbreviated to crank, is the part of an engine which translates reciprocating linear motion of the piston 404 into rotation. I.e., the linear back-and-forth motion of the piston 404 is converted into rotation of the crankshaft 408. The crankshaft 408 can be connected to a flywheel, to reduce the pulsation characteristic piston 404 movement, and sometimes a torsional or vibrational damper at the opposite end, to reduce the torsion vibrations often caused along the length of the crankshaft by the cylinders farthest from the output end acting on the torsional elasticity of the metal.

Once the pistons are firing and the crankshaft 408 is spinning, this energy must be converted, or transmitted, to drive the auger. But the crankshaft 408 spins only within a limited range, usually between 1,000 to 9,000 revolutions per minute (rpm), and this is not enough power to cause the auger to turn when applied directly. The transmission accomplished the task of brining the engine's torque (the amount of twisting force the crankshaft 408 has as it spins) to a range that will turn the auger (which rotates at 0 to 600 rpm).

FIG. 4 also shows that the reciprocating engine 400 can include a connecting rod 410. The connecting rod 410 can connect the piston 404 to the crankshaft 408. For example, it can impart the linear force of the piston 404 to the crankshaft 408. Additionally or alternatively, the connecting rod 410 can convert rotating motion from the crankshaft 408 into linear motion of the piston 404. To convert the reciprocating motion into rotation, the crankshaft 408 can include crank throws, also called crankpins, or other bearing surfaces whose axis is offset from that of the crankshaft 408 and to which the connecting rod 410 can be connected. In at least one implementation, the connecting rod 410 can be rigid in order to transmit either a push or a pull from the piston 404 and so the connecting rod 410 can rotate the crankshaft 408 through both halves of a revolution.

FIG. 4 further shows that the reciprocating engine 400 can include a first valve 412a and a second valve 412b (collectively “valves 412”). The valves 412 can control the flow of gases into or out of the cylinder 402. In particular, the valves 412 can be biased into the open position using a spring or some other mechanism and can be closed when necessary.

FIG. 4 additionally shows that reciprocating engine 400 can include a first camshaft 414a and a second camshaft 414b (collectively “camshafts 414”). The camshaft 414 can include a shaft which includes a disk or cylinder having an irregular form such that its motion, usually rotary, gives to a part or parts in contact with it a specific rocking or reciprocating motion. In particular, the first camshaft 414a and the second camshaft 414b can rotate, providing regular intervals at which the first valves 412a and the second valve 412b respectively, are opened and closed.

FIG. 4 also shows that the reciprocating engine 400 can include an intake port 416a and an exhaust port 416b (collectively “ports 416”). The intake port 416a can be used to allow fuel, air or a fuel/air mixture into the cylinder 402, where it will expand to drive the piston 404 and the exhaust port 416b can allow waste gases to exit the cylinder 402.

FIG. 4 further shows that the reciprocating engine 400 can include a spark plug 418. A spark plug 418 is an electrical device that fits into the cylinder 402 and ignites the fuel/air mixture by means of an electric spark. In particular, the spark plug 418 can include an insulated central electrode which is connected by a heavily insulated wire to an ignition coil or magneto circuit on the outside, forming, with a grounded terminal on the base of the plug, a spark gap inside the cylinder 402.

By way of example to show the operation of the reciprocating engine 400, in a 4-stroke engine, the first camshaft 414a can open the first valve 412a when the piston 404 is near the top of the cylinder 402. As the piston 404 moves toward the bottom of the cylinder 402 the movement can “pull” a fuel/air mixture into the cylinder 402. The first valve 412a can be closed and as the piston 404a moves toward the top of the cylinder 402, the fuel/air mixture is compressed. The spark plug 418 can then be used to ignite to fuel/air mixture. The resulting expansion can drive the piston 404 toward the bottom of the cylinder 402. The second cam shaft 414a can then open the second valve 412a and as the piston 404 moves toward the top of the cylinder 402 the exhaust gases can be pushed out of the cylinder 402 and the cycle can begin again.

### IV. Planetary Transmission

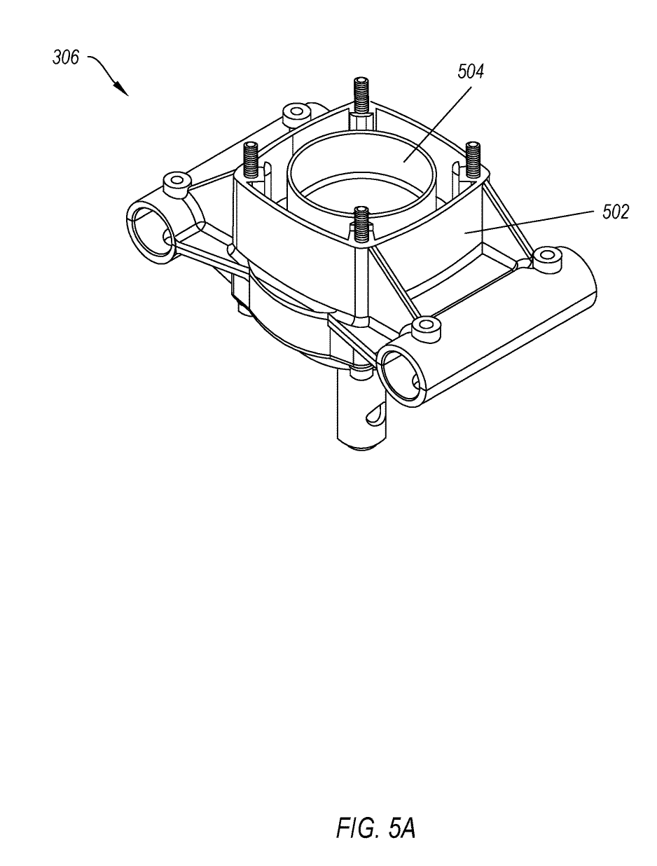

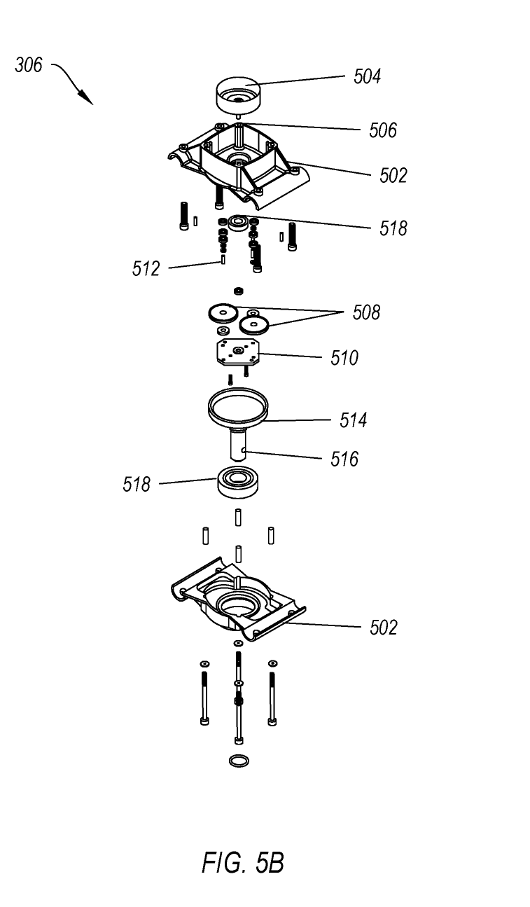

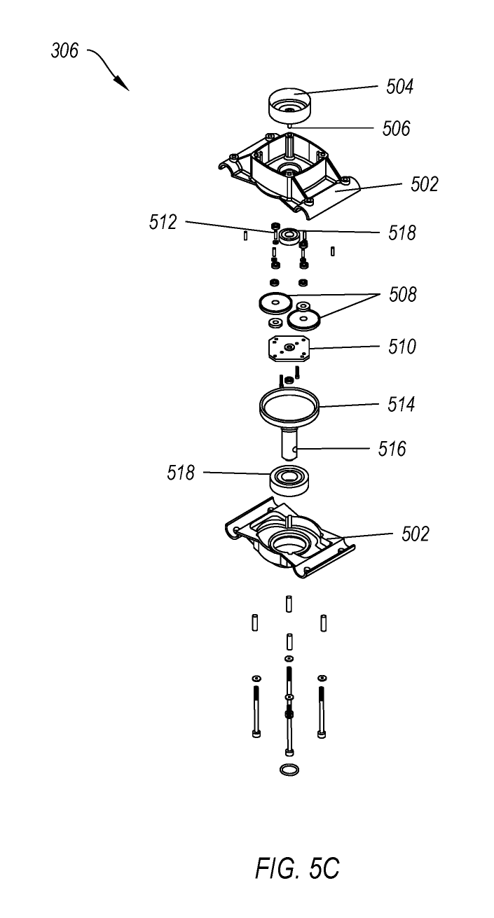

FIGS. 5A, 5B and 5C (collectively “Figure 5”) illustrates an example of a planetary transmission 306 (epicyclic gear train). FIG. 5A illustrates an example of a fully assembled planetary transmission 306; FIG. 5B illustrates an example of an expanded view of planetary transmission 306 with a 15:1 gear ratio; and FIG. 5C illustrates an example of an expanded view of planetary transmission 306 with a 24:1 gear ratio. The planetary transmission 306 can be incorporated with a power source (e.g., propane engine, gasoline engine, electric motor) on various hand-held products, for example an ice auger. In particular, the planetary transmission 306 receives an input torque that has a right-hand rotation (such as from a power source) but it is critical that the output be left-hand rotation (for example, to preserve continuity with existing ice auger parts). In addition, the planetary transmission 306 allows for a quick conversion between gear ratios. For example, different gear ratios can be achieved by changing the inner diameter (i.e., diameter of the small pinion gear) and/or number of teeth of the pinion and/or the diameter and number of teeth of the planetary gears. For example, when used in an ice auger the planetary transmission 306 can achieve gear ratios of 24:1 and 15:1. These gear ratios can be critical in order to achieve the proper rotation of the auger and cutting head for proper ice drill operation.

Moreover, the planetary transmission 306 also allows for connection to the power source either through a clutch or via direct connection. That is, the planetary transmission 306 allows for use in either a clutch drive or direct drive system. The planetary transmission 306 allows for ease of interchangeability (for example, the consumer may easily remove the planetary transmission 306 and replace it with a new planetary transmission 306 by removing four bolts). Likewise, the planetary transmission 306 can incorporate handles that allows the consumer to easily remove the handles from the planetary transmission 306 during replacement. In particular, a user can slide the handles into the handle slots and tighten the bolts, which is very simple and easy to assemble.

In addition, the planetary transmission 306 prevents multiple issues that result from conventional transmissions. For example, there can be two drive gears engaged to the pinion gear. This doubles the metal to metal gear contact in a smaller footprint creating a much stronger/durable product. Additionally, the planetary transmission 306 can be centered directly under the engine. This creates a more balanced auger which is easier to operate and to start a hole with an enhanced ability for a more vertical cut in the ice. The vertical cut allows for a quick clean cut, easier removal of ice chips accumulating in the ice hole, and greater fuel efficiency of the engine. Moreover, the design is so efficient you can turn the planetary transmission 306 by hand and it spins with little or no effort (i.e., there is very little gear drag). Further, the operator is in a much safer space with the auger properly balanced in his/her hands. Added benefits of the design include a cast aluminum housing vs. a plastic composite material, aluminum is way more durable in cold weather applications as opposed to plastic. The planetary design is a totally sealed design, never needs lubricating, and if does mechanically fail a new replacement transmission can be installed little effort. These benefits have drastically reduced the number of transmission failures in ice augers.

FIG. 5 shows that the planetary transmission 306 can include a housing 502. In at least one implementation, the housing 502 is configured to withstand the transmission of forces from the engine to the auger in an ice drill. I.e., the housing 502 must be of sufficient strength to ensure that the planetary transmission 306 can withstand the forces produced by the engine and by the auger. Thus, the housing 502 may be constructed of any desired material, such as steel or aluminum. Additionally or alternatively, the housing 502 is configured to align the other components of the planetary transmission 306. I.e., the housing 502 can allow the internal and external components of the planetary transmission 306 to be installed and proper spacing to be maintained among the components. Thus, the housing 502 can allow for interchangeability between transmissions.

FIG. 5 also shows that the planetary transmission 306 can include a clutch drum 504. The clutch drum 504 is a mechanical device which engages and disengages the planetary transmission 306 from a driving shaft to a driven shaft. That is, the clutch drum 504 can be used to connect two shafts such that they may be locked together and spin at the same speed (engaged), locked together but spinning at different speeds (slipping), or unlocked and spinning at different speeds (disengaged).

FIG. 5 additionally shows that the planetary transmission 306 can include a pinion gear 506 (aka “sun gear”). The pinion gear 506 is attached to the clutch drum 504 so that when the clutch drum 504 is engaged the pinion gear 506 is rotated at the same speed (in rpm) as the input from the engine. I.e., if the output of the engine is 1500 rpm, then when the clutch drum 504 is engaged the pinion gear 506 rotates at the same speed of 1500 rpm.

FIG. 5 also shows that the planetary transmission 306 can include one or more planetary gears 508 (aka “planet gears”). The planetary gears 508 are in operational contact with the pinion gear 506. I.e., the teeth on the exterior of the planetary gears 508 engage the teeth on the exterior of the pinion gear 506 such that when rotation of the pinion gear 506 is transmitted to the planetary gears 508, the planetary gears 508 rotate about the pinion gear 506 in a hypocycloid manner.

FIG. 5 further shows that the planetary transmission 306 can include a gear bracket 510 (aka “carrier”). The gear bracket 510 is attached to and supports the planetary gears 508. I.e., as the planetary gears 508 are rotated by and move around the pinion gear 506, the gear bracket 510 maintains the planetary gears 508 in the proper plane.

FIG. 5 moreover shows that the planetary transmission 306 can include a dowel pin 512. The dowel pin 512 holds the planetary gears 508 in place relative to the gear bracket 510. For example, the dowel pin 512 can include one or more features on the surface which allow rotation of the planetary gears 508. E.g., the dowel pin 512 can include a smooth surface which allows rotation of the planetary gears 508 relative to the gear bracket 510. Likewise, the dowel pin 512 can prevent lateral motion of the planetary gears 508, ensuring that the planetary gears 508 remain locked with the pinion gear 506.

FIG. 5 further shows that the planetary transmission 306 can include a ring gear 514 (aka “annulus”). The ring gear 514 includes inward facing teeth. That is, the teeth of the ring gear 514 are on the interior of a cylinder, rather than the exterior of a cylinder (and the exterior of the ring gear may be smooth or have another desired texture). The ring gar 514 is in operational contact with the planetary gears 508. I.e., the teeth of the ring gear 514 engage the teeth of the planetary gears 508. Thus, rotation of the gear bracket 510 is transmitted through the planetary gears 508 to the ring gear 514 with a desired gear ratio.

FIG. 5 additionally shows that the planetary transmission 306 can include an output shaft 516. The output shaft 516 is connected to the ring rear 514. Thus, all energy input into the transmission is output along the output shaft 516 at a desired gear ratio. So, for example, if the input speed is 1500 rpm the output shaft 516 rotates only at 100 rpm if the gear ratio if 15:1 or at 62.5 rpm if the gear ratio is 24:1, which is much slower but each rotation includes more torque, which is used to driver the auger into the ice which is being cut.

FIG. 5 moreover shows that the planetary transmission can include one or more bearings 518. A bearing 518 is a machine element that constrains relative motion to only the desired motion, and reduces friction between moving parts. The design of the bearing 518 allows free rotation around a fixed axis. Rotary bearings 518 hold rotating components such as shafts or axles within mechanical systems, and transfer axial and radial loads from the source of the load to the structure supporting it. The simplest form of bearing, the plain bearing, consists of a shaft rotating in a hole. Lubrication is often used to reduce friction. In the ball bearing 518 and roller bearing, to prevent sliding friction, rolling elements such as rollers or balls with a circular cross-section are located between the races or journals of the bearing 518 assembly.

One of skill in the art will appreciate that multiple combinations of pinion gear 506, gear bracket 510, dowel pin 512, and set of planetary gears 508 (collectively called a “planetary gear train”) can be placed in parallel. For example, two planetary gear trains can be placed in parallel to allow for each to accomplish partial transmission of forces to the output shaft 516. This relieves stress on planetary gear train.

One of skill in the art will additionally appreciate that the efficiency loss in the planetary transmission 306 is minimal per stage. This type of efficiency ensures that a high proportion of the power being input is transmitted through the planetary transmission 306, rather than being wasted as heat or mechanical losses inside the planetary transmission 306. Further, one of skill in the art will appreciate that the load in the planetary transmission 306 is shared among multiple planetary gears 508; therefore, internal torque is uniformly distributed. The more planetary gear trains in the system, the greater load distribution and higher torque dispersal through the gearing.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An ice drill, the ice drill comprising:
a power head, the power head configured to allow the user to control operation of the ice drill;
an engine, the engine producing an output rotation at a crankshaft;
a planetary transmission, the planetary transmission:
receiving the output rotation from the crankshaft;
changing the rotation speed by a specified ratio; and
outputting the rotation at an output shaft, wherein the output rotation is left-handed in orientation;
an auger, the auger attached to the output shaft; and
a cutting blade, the cutting blade configured to be moved by the auger to create a hole in ice.

2. The ice drill of claim 1, wherein the planetary transmission is centered horizontally relative to the power head.

3. The ice drill of claim 1, wherein the specified ratio is 15:1.

4. The ice drill of claim 1, wherein the specified ratio is 24:1.

5. The ice drill of claim 1, wherein the planetary transmission includes:
a clutch drum, wherein the clutch drum allows the engine and the planetary transmission to be disengaged from one another.

6. An ice drill, the ice drill comprising:
a power head, the power head configured to allow the user to control operation of the ice drill;
an engine, the engine producing a right-handed output rotation at a crankshaft;
a planetary transmission, the planetary transmission including:
a pinion gear, the pinion gear:
connected to the output rotation of the engine; and
receiving the output rotation from the crankshaft;
a set of planetary gears, the planetary gears each in operational contact with the pinion gear;
a gear bracket, the gear bracket maintaining the position of the planetary gears relative to the pinion gear;
a ring gear, the ring gear including inward facing teeth that are in operational contact with each of the planetary gears in the set of planetary gears such that:
the rotation speed has been changed by a specified ratio; and
the rotation has been changed to left-handed in orientation; and
an output shaft connected to the ring gear;
an auger, the auger attached to the output shaft; and
a cutting blade, the cutting blade configured to be moved by the auger to create a hole in ice.

7. The ice drill of claim 6, further comprising:
a set of dowels, each dowel in the set of dowels:
connecting a planetary gear in the set of planetary gears to the gear bracket; and
allowing the connected planetary gear to rotate relative the pinion gear.

8. The ice drill of claim 6 wherein the pinion gear is composed of steel.

9. The ice drill of claim 6 wherein each of the planetary gears is composed of steel.

10. The ice drill of claim 6 wherein the ring gear is composed of steel.

11. The ice drill of claim 6 wherein the gear bracket is composed of steel.

12. An ice drill, the ice drill comprising:
a power head, the power head configured to allow the user to control operation of the ice drill;
an engine, the engine producing a right-handed output rotation at a crankshaft;
a planetary transmission, the planetary transmission including:
a housing;
a pinion gear, the pinion gear:
connected to the output rotation of the engine; and
receiving the output rotation from the crankshaft;
a set of planetary gears, the planetary gears each in operational contact with the pinion gear;
a gear bracket, the gear bracket maintaining the position of the planetary gears relative to the pinion gear;
a ring gear, the ring gear including inward facing teeth that are in operational contact with each of the planetary gears in the set of planetary gears such that:
the rotation speed has been changed by a specified ratio; and
has been changed to left-handed in orientation; and
an output shaft connected to the ring gear;
wherein the housing is releasably attached to the power head; and
an auger, the auger attached to the output shaft; and
a cutting blade, the cutting blade configured to be moved by the auger to create a hole in ice.

13. The ice drill of claim 12, wherein the releasable attachment between the housing and the power head includes a set of bolts.

14. The ice drill of claim 12, wherein the planetary transmission includes one or more rotary bearings.

15. The ice drill of claim 14, wherein the one or more rotary bearings includes:
a rotary bearing between the pinion gear and the housing.

16. The ice drill of claim 14, wherein the one or more rotary bearings includes:
a rotary bearing between the ring gear and the housing.

17. The ice drill of claim 12, wherein the housing is composed of steel.

18. The ice drill of claim 12, wherein the housing is composed of aluminum.

19. The ice drill of claim 12, wherein the housing includes one or more handles.
